(19) United States
(12) Patent Application Publication
(10) Pub. No.: US 2018/0124476 A1
(43) Pub. Date: May 3, 2018

(54) SYSTEM, INFORMATION PROCESSING DEVICE AND NON-TRANSITORY COMPUTER-READABLE STORAGE MEDIUM

(71) Applicant: FUJITSU LIMITED, Kawasaki-shi (JP)

(72) Inventors: Akira NAKAGAWA, Sagamihara (JP); Keizo Kato, Kawasaki (JP); Kensuke KURAKI, Ichikawa (JP); RYUTA TANAKA, Machida (JP); Toshiyuki Fukuoka, Kawasaki (JP)

(73) Assignee: FUJITSU LIMITED, Kawasaki-shi (JP)

(21) Appl. No.: 15/787,275

(22) Filed: Oct. 18, 2017

(30) Foreign Application Priority Data
Oct. 31, 2016 (JP) 2016-212969

(51) Int. Cl. H04N 21/8358; G06T 1/00; G06K 9/46; H04N 21/254; H04N 21/4627; H04N 21/488; H04N 21/63; H04N 21/2389; H04N 21/4788

(52) U.S. Cl. CPC H04N 21/8358; G06T 1/0042; G06K 9/4604; H04N 21/2541; H04N 21/4788; H04N 21/4882; H04N 21/632; H04N 21/23892; H04N 21/4627

(57) ABSTRACT

A system includes a light irradiating device configured to irradiate an object with light to illuminate a mark on the object, and an information processing device storing relation information and control information associated with the object, the relation information indicating a relation between the mark and the object, and the control information indicating a policy whether to distribute an image of the object to at least one device through a network, and configured to acquire the image of the object irradiated with the light to illuminate the mark on the object, extract the mark illuminated by the light on the object, identify the object associated with the extracted mark based on the relation information, and execute a process to control distribution of the image to the at least one device through the network, according to the policy for the image of the object in the control information.

### CROSS-REFERENCE TO RELATED APPLICATION

This application is based upon and claims the benefit of priority of the prior Japanese Patent Application No. 2016-212969, filed on Oct. 31, 2016, the entire contents of which are incorporated herein by reference.

### FIELD

The embodiment discussed herein is related to a system, an information processing device and a non-transitory computer-readable storage medium.

### BACKGROUND

Recording of content of a moving image of a television program, a movie, or the like without permission and posting of the content to a video posting site or a social networking service (SNS) without permission have been deemed as a problem. However, automatic deletion of content is enabled by use of an electronic fingerprint technique. For example, the electronic fingerprint technique may be a technique to extract a feature of a temporal change from an image or sound of a moving image and the right holder of the content provide the feature (electronic fingerprint) to the operator of a video posting site or an SNS in advance. The operator may automatically determine whether or not the provided electronic fingerprint is included in the posted content, and carry out handling such as deletion of the content if the electronic fingerprint is included.

Meanwhile, a technique has been disclosed in which whether or not use of content is possible may be determined based on copyright limitation information and license information and charging processing may be executed according to the determination result. However, this technique is a technique to determine whether or not a user has the license and is not a technique for coping with content posted without permission. Examples of the related art include Japanese Laid-open Patent Publication No. 2006-39918, and “Fast and Accurate Near-Duplicate Video Detection Based on Binarized Luminance Centroid and Adaptive Feature Comparison”, Uchida et. al., The Institute of Electronics, Information and Communication Engineers Journal D Vol. J93-D No. 9 pp. 1714-1716.

### SUMMARY

According to an aspect of the embodiment, a system includes a light irradiating device configured to irradiate an object with light to illuminate a mark on the object, and an information processing device including a first memory configured to store relation information and control information associated with the object, the relation information indicating a relation between the mark and the object, and the control information indicating a policy whether to distribute an image of the object to at least one device through a network, and a first processor coupled to the first memory and configured to acquire the image obtained by a photograph of the object irradiated with the light to illuminate the mark on the object, extract, from the image, the mark illuminated by the light on the object, identify, from the image, the object associated with the extracted mark based on the relation information, and execute a process to control distribution of the image to the at least one device through the network, according to the policy for the image of the object in the control information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a system according to one embodiment;

FIG. 2 is a diagram illustrating a configuration example of an illuminating device;

FIG. 3 is a diagram illustrating a data structure example of an event information management table;

FIG. 4 is a diagram illustrating a data structure example of a moving image management table;

FIG. 5 is a diagram illustrating a data structure example of an access history table;

FIG. 6 is a diagram illustrating a hardware configuration example of an event information managing device and so forth;

FIG. 7 is a sequence diagram (first diagram) illustrating a processing example of the embodiment;

FIG. 8 is a flowchart (first flowchart) illustrating a processing example of release control;

FIG. 9 is a flowchart (second flowchart) illustrating a processing example of release control;

FIG. 10 is a sequence diagram (second diagram) illustrating a processing example of the embodiment;

FIG. 11 is a diagram illustrating an example of user information; and

FIG. 12 is a diagram illustrating an example of provided information to a right holder.

### DESCRIPTION OF EMBODIMENT

As described above, regarding fixed-form content such as a television program or a movie, coping with posting without permission has come to be carried out by the electronic fingerprint. However, it is difficult to apply the electronic fingerprint to content secretly capturing or recording an image by a camera (for example, photographed) by an audience member without obedience to instructions and intension of the organizer in an event such as a concert. This is because of the following reason. In the event such as a concert, because the positions of photographing by audience members are different from each other, it is difficult to extract a feature unique to the event from an image. In addition, also regarding the sound, it is difficult to extract a unique feature because of difference in how the sound is heard due to noise such as applause and cheers and the audience member position.

For this reason, a person visually checks whether posted content is permitted or unpermitted. Because several millions of pieces of content are posted to a video posting site or the like per one day, it is not practical to visually check all of the pieces of content and it is difficult to detect fraudulent posting.

Furthermore, recently, a new promotion method has also been introduced in which photographing is permitted regarding all or part of pieces of music or the like in concerts by various singers and the photographed content is aggressively shared in a video sharing site or an SNS to promote spreading. However, as described above, it is difficult to discriminate an event such as a concert from posted content and therefore it is difficult to develop such a promotion.

A preferred embodiment of the disclosed techniques will be described below.

<System Configuration>

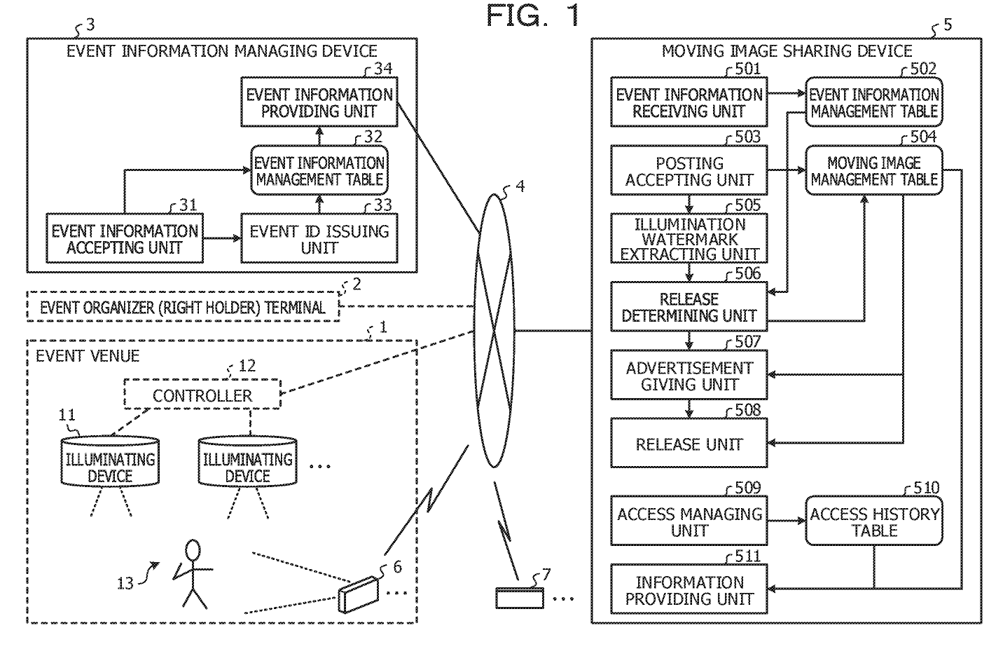

FIG. 1 is a diagram illustrating a configuration example of a system according to one embodiment. In FIG. 1, at an event venue 1 of a concert, a trade show, or the like, one or more illuminating devices 11 that may embed an illumination watermark in irradiation light are provided. The embedded illumination watermark may be extracted from a moving image obtained by photographing a subject 13 irradiated with light by the illuminating devices 11 by a portable terminal 6 such as a smartphone. Setting of information embedded as the illumination watermark is manually carried out on the illuminating devices 11 individually or is carried out through a controller 12 if the controller 12 is installed. If the controller 12 is a stand-alone type, the setting is manually carried out on the controller 12. If the controller 12 is a network type, the setting of the information may be carried out online on the controller 12 through a network 4 such as the Internet.

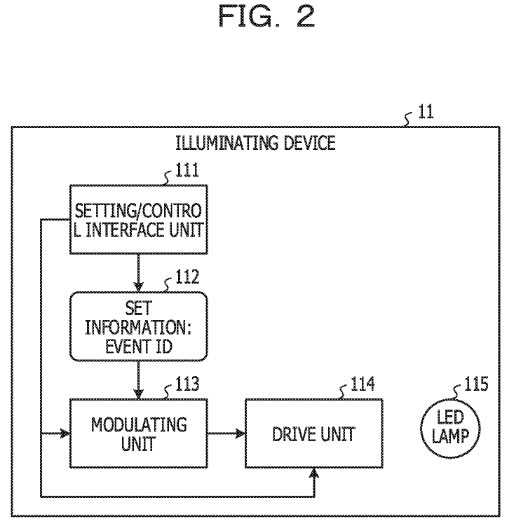

FIG. 2 is a diagram illustrating a configuration example of an illuminating device. The illuminating device may be the illuminating device 11 illustrated in FIG. 1. In FIG. 2, the illuminating device 11 includes a setting/control interface unit 111, set information 112, a modulating unit 113, a drive unit 114, and a light-emitting diode (LED) lamp 115. The setting/control interface unit 111 has functions of accepting setting of information to be embedded as an illumination watermark manually or online to store the information as the set information 112 and controlling turning-on/off of the illumination and the intensity, color, and so forth of illumination light. As the set information 112, an event identifier (ID) to identify the event is used here. For example, if the event is a concert, one event ID may be allocated to the whole of the concert or the event ID may be allocated to each of pieces of music performed in the concert. The event ID is an ID to identify the event in order to carry out handling different for each event in a moving image sharing device 5 to be described later and is issued in such a manner as not to overlap with the event ID of a different event.

The modulating unit 113 has a function of modulating the intensity (brightness) or color of light based on the set information 112 under control by the setting/control interface unit 111. The drive unit 114 is a unit that supplies voltage and current for driving to the LED lamp 115 in accordance with output of the modulating unit 113 under control by the setting/control interface unit 111.

Referring back to FIG. 1, an event organizer (right holder) terminal 2 is an information processing device that carries out registration of event information in an event information managing device 3 to be described later, acquisition of an event ID from the event information managing device 3, setting of the event ID to the controller 12, and so forth. If these kinds of processing are manually executed, the event organizer terminal 2 may be omitted.

The event information managing device 3 has a function of accepting registration of event information and issuing an event ID and includes an event information accepting unit 31, an event information management table 32, an event ID issuing unit 33, and an event information providing unit 34. The event information accepting unit 31 has a function of accepting registration of event information from the event organizer terminal 2 or directly and registering the event information in the event information management table 32 together with an event ID issued by the event ID issuing unit 33. Furthermore, the event information accepting unit 31 also has a function of providing the event ID issued by the event ID issuing unit 33 to the organizer.

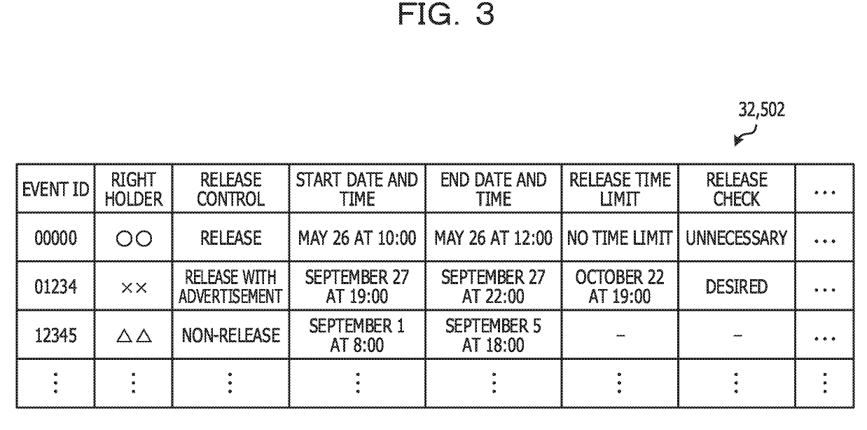

FIG. 3 illustrates an example of an event information management table and this example includes items of “event ID,” “right holder,” “release control,” “start date and time,” “end date and time,” “release time limit,” and “release check.” The event information management table may be the event information management table 32 illustrated in FIG. 1. The “event ID” is identification information to identify the event. The event ID is information issued for each event without overlapping and may be a simple serial number or an alphanumeric character string. By combining information that indicates the place where the event is held, information that indicates the date and time when the event is held (start date and time, end date and time, or the like), and so forth, the event ID may be issued without checking overlapping. The “right holder” is information to identify the owner of the copyright or the like about the event. The “right holder” may be accompanied by information such as an e-mail address that will become the destination of information provision later or the e-mail address or the like may be managed regarding each right holder separately.

The “release control” is information that prescribes handling such as whether or not to permit a release when a moving image obtained by photographing the contents of the event is posted, and includes “release,” “release with advertisement,” and “non-release.” The “release” indicates that a release is permitted. The “release with advertisement” indicates that a release is permitted in the state in which an advertisement of a type on which agreement has been reached between the organizer and the operator of moving image sharing in advance is given. In the case of the “release with advertisement,” the information of the “release control” may be accompanied by information to identify the type of the advertisement in addition to the information indicating that the “release control” is the “release with advertisement,” or the type of the advertisement may be managed in association with the event ID separately. The “non-release” indicates that a release is not permitted. In the case of the “non-release,” normally the operator of moving image sharing deletes the moving image after holding the moving image for a given period. However, specifying “deletion” to aggressively require deletion may be allowed.

The “start date and time” is information that indicates the start date and time of the event. The “end date and time” is information that indicates the end date and time of the event. The “release time limit” is information that indicates the date and time when the release ends when the “release control” is the “release” or the “release with advertisement.” The “release check” is information that indicates whether an advance check by the right holder before the actual release is desired or unnecessary when the “release control” is the “release” or the “release with advertisement.” If the “release check” is “desired,” the moving image ID of each of posted moving images is notified to the right holder to enable processing of checking each moving image individually. Information about the event venue may be included in the event information although not included in the example of FIG. 3.

Referring back to FIG. 1, the event ID issuing unit 33 has a function of issuing an event ID when the event information accepting unit 31 accepts registration of event information from the organizer. The event information providing unit 34 has a function of notifying the moving image sharing device 5 of the contents of the event information management table 32 through the network 4 at a given timing.

The event information managing device 3 may be a device operated by a business operator independent of the organizer of an event and the operator of the moving image sharing device 5 or may be a device operated by the organizer of an event or the operator of the moving image sharing device 5. If the event information managing device 3 is operated by the operator of the moving image sharing device 5, the functions of the event information managing device 3 may be included in the moving image sharing device 5.

The moving image sharing device 5 is a control device of a video posting site or an SNS. The moving image sharing device 5 includes an event information receiving unit 501, an event information management table 502, a posting accepting unit 503, a moving image management table 504, an illumination watermark extracting unit 505, a release determining unit 506, an advertisement giving unit 507, and a release unit 508. Furthermore, the moving image sharing device 5 includes an access managing unit 509, an access history table 510, and an information providing unit 511.

The event information receiving unit 501 has a function of receiving a notification of the contents of the event information management table 32 from the event information providing unit 34 of the event information managing device 3 through the network 4 and registering the contents in the event information management table 502. The contents of the event information management table 502 are similar to the contents of the event information management table 32 illustrated in FIG. 3.

Referring back to FIG. 1, the posting accepting unit 503 has a function of accepting posting of a moving image photographed by an audience member with the portable terminal 6 such as an own smartphone at the event venue 1 and storing the moving image in a given place (uniform resource locator (URL)). In the posting of the moving image, posting of a moving image of the streaming format as live broadcasting is also included besides posting based on the format of a moving image file generated at the timing of completion of the photographing.

The illumination watermark extracting unit 505 has a function of analyzing the posted moving image and extracting an embedded illumination watermark. As described above, the illumination watermark is superimposed on illumination light. Based on change in the brightness or color obtained from the difference of images of the respective frames of the moving image, information on the embedded illumination watermark (here, event ID) may be extracted from change in a given time. For more information, refer to International Publication Pamphlet No. WO 2016/046862, for example.

The release determining unit 506 has a function of determining the handling method such as whether or not to permit a release according to whether or not an event ID based on the illumination watermark has been extracted by the illumination watermark extracting unit 505, whether or not the extracted event ID is registered in the event information management table 502, and so forth. Furthermore, the release determining unit 506 also has a function of copying given information from the event information management table 502 and registering the information in the moving image management table 504.

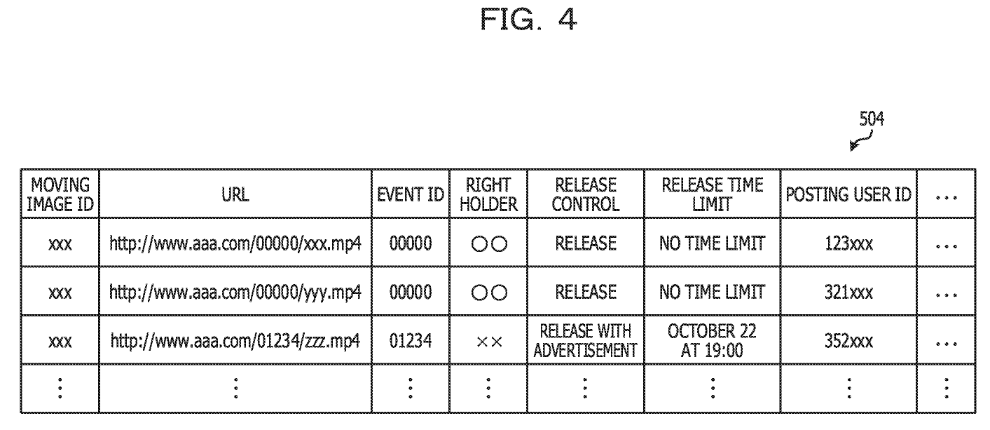

FIG. 4 illustrates an example of a moving image management table and this example includes items of “moving image ID,”“URL,”“event ID,” “right holder,” “release control,” “release time limit,” and “posting user ID.” The moving image management table may be the moving image management table 504 illustrated in FIG. 1. The “moving image ID” is identification information to identify the moving image and moving image IDs that do not overlap are given. The “URL” is information that indicates the place where the moving image is stored. The “event ID” is the event ID acquired from the illumination watermark embedded in the moving image. The “right holder,” the “release control,” and the “release time limit” are information acquired from the event information management table 502 (FIG. 3) based on the event ID. The “posting user ID” is identification information of the user who has posted the moving image. In the present embodiment, to provide information on the user who has posted the moving image and the user who has viewed the moving image to the right holder, users who have completed membership registration are envisaged.

Referring back to FIG. 1, the advertisement giving unit 507 has a function of giving a given advertisement to a moving image if the release control is the “release with advertisement.” The release unit 508 has a function of setting a posted moving image to the state of being accessible from the external to release the moving image if the release control is “release” or “release with advertisement.”

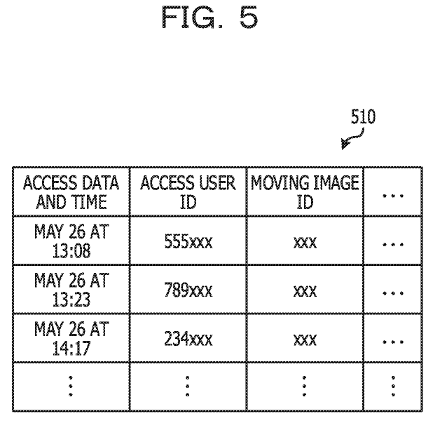

The access managing unit 509 has a function of recording an access history in the access history table 510 if access for viewing is made from a portable terminal 7 or the like to a released moving image. FIG. 5 illustrates a data example of an access history table and this example includes items of “access date and time,” “access user ID,” and “moving image ID.” The access history table may be the access history table 510 illustrated in FIG. 1. The “access date and time” is information on the date and time when access for viewing has been made. The “access user ID” is identification information of the user who has made access for viewing. The “moving image ID” is identification information to identify the moving image.

Referring back to FIG. 1, the information providing unit 511 has a function of generating provided information about posting and viewing of moving images and providing the information to the right holder (organizer) for secondary use such as promotion by the right holder (organizer) of an event. The provision of information is carried out offline (data provision by media or the like) in some cases besides being carried out online.

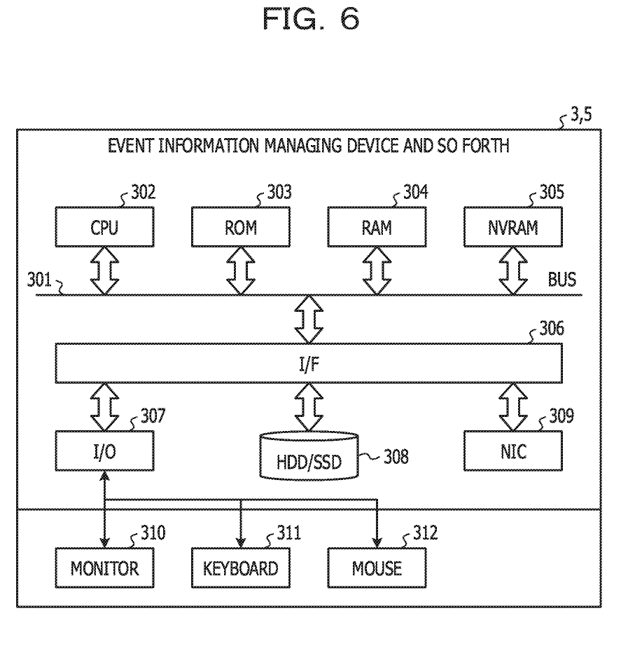

FIG. 6 is a diagram illustrating a hardware configuration example of an event information managing device, a moving image sharing device, and so forth. The event information managing device and the moving image sharing device may be the event information managing device 3 the moving image sharing device 5 illustrated in FIG. 1. In FIG. 6, the event information managing device 3 and so forth include a central processing unit (CPU) 302, a read only memory (ROM) 303, a random access memory (RAM) 304, and a non-volatile random access memory (NVRAM) 305 that are coupled to a system bus 301. Furthermore, the event information managing device 3 and so forth include an interface (I/F) 306 and an input/output device (I/O) 307, a hard disk drive (HDD)/solid state drive (SSD) 308, and a network interface card (NIC) 309 that are coupled to the I/F 306. Moreover, the event information managing device 3 and so forth include a monitor 310, a keyboard 311, and a mouse 312 that are coupled to the I/O 307. It is also possible to couple a compact disk/digital versatile disk (CD/DVD) drive or the like to the I/O 307.

Functions of the event information managing device 3, the moving image sharing device 5, and so forth described in FIG. 1 are implemented through execution of a given program in the CPU 302. The program may be a program acquired via a recording medium or may be a program acquired via a network or may be embedded in the ROM.

<Operation>

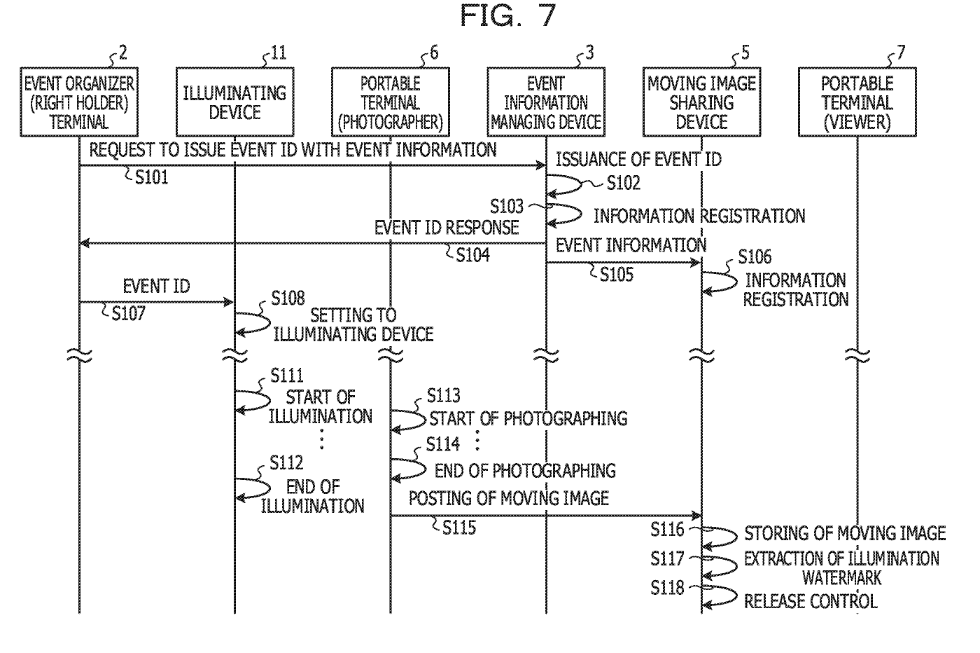

FIG. 7 is a sequence diagram illustrating a processing example of the above-described embodiment. In FIG. 7, before an event is started, the organizer of the event makes a request to issue an event ID with event information from the event organizer terminal 2 to the event information managing device 3, for example, (step S101). The event information provided from the organizer includes the right holder, the release control, the start date and time, the end date and time, the release time limit, and the release check.

When accepting the request to issue an event ID, the event information accepting unit 31 of the event information managing device 3 issues an event ID by the event ID issuing unit 33 (step S102). Then, the event information accepting unit 31 registers the event information provided from the organizer and the issued event ID in the event information management table 32 (step S103) and transmits the issued event ID to the event organizer terminal 2 as a response (step S104).

Furthermore, the event information providing unit 34 notifies the moving image sharing device 5 of the contents of the event information management table 32 through the network 4 (step S105) and the event information receiving unit 501 registers the received information in the event information management table 502 (step S106).

Meanwhile, for example, the organizer that has acquired the event ID notifies the event ID to the controller 12 at the event venue 1 from the event organizer terminal 2 (step S107) and the controller 12 sets the event ID in the illuminating device 11 (step S108). Although the case in which the organizer carries out the acquisition of the event ID and the setting to the illuminating device 11 online by using the event organizer terminal 2 is described, the organizer may carry out the acquisition of the event ID and the setting to the illuminating device 11 manually (offline) as described above.

Thereafter, when the event is started at the event venue 1, the illuminating device 11 starts illumination including an illumination watermark (step S111) and ends the illumination due to the end of the event (step S112).

Suppose that, in the middle of the event, an audience member starts photographing of the event by the own portable terminal 6 (step S113) and ends the photographing (step S114) and posts a moving image obtained by the photographing to the moving image sharing device 5 (step S115). Although the sequence of the case of posting based on the format of a moving image file generated at the timing of completion of photographing is illustrated, if a moving image of the streaming format is posted as live broadcasting, posting of a moving image (step S115) with photographing is started by operation of start of the posting.

When accepting the posting of the moving image, the posting accepting unit 503 of the moving image sharing device 5 stores the moving image in a given place (step S116). In the case of posting of a moving image of the streaming format, temporary storing (buffering) is carried out. If recording is carried out, permanent storing is also carried out.

Next, the illumination watermark extracting unit 505 analyzes the posted moving image and extracts the embedded illumination watermark (step S117).

Then, the release determining unit 506 determines the handling method such as whether or not to permit a release according to whether or not an event ID based on the illumination watermark has been extracted, whether or not the extracted event ID is registered, and so forth, and carries out release control by using the advertisement giving unit 507 and the release unit 508 (step S118).

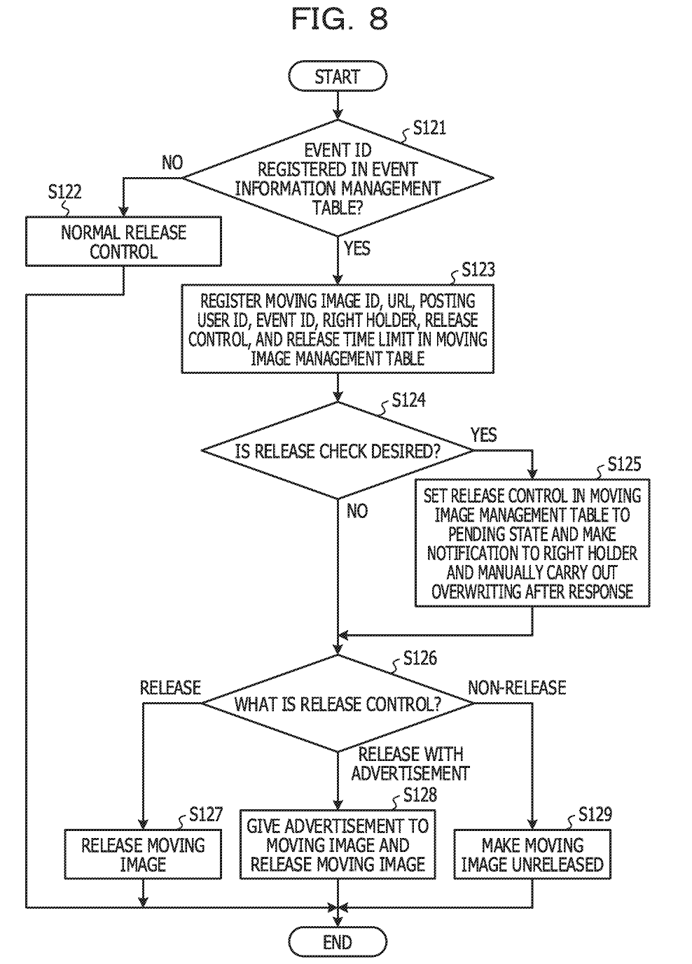

FIG. 8 illustrates a processing example of release control by a release determining unit, an advertisement giving unit, and a release unit. The release determining unit, the advertisement giving unit, and the release unit may be the release determining unit 506, the advertisement giving unit 507, and the release unit 508 illustrated in FIG. 1. In FIG. 8, the release determining unit 506 determines whether or not what is extracted from the illumination watermark is an event ID registered in the event information management table 502 (step S121). If determining that what is extracted from the illumination watermark is not an event ID registered in the event information management table 502 (including the case in which the illumination watermark is not included in the moving image) (No of the step S121), the release determining unit 506 carries out the similar release control as posting of a normal moving image (step S122). For example, the release determining unit 506 carries out filtering by an electronic fingerprint or the like or releases the moving image unconditionally.

If determining that what is extracted from the illumination watermark is an event ID registered in the event information management table 502 (Yes of the step S121), the release determining unit 506 registers information in the moving image management table 504 (step S123). For example, the release determining unit 506 registers a moving image ID that is newly issued, the URL of the place where the moving image is stored at the time of acceptance, a posting user ID, the event ID, and the right holder, the release control, and the release time limit that are associated with the event ID in the event information management table 502.

Next, the release determining unit 506 determines whether or not the release check corresponding to the event ID in the event information management table 502 is “desired” (step S124). If determining that the release check is “desired” (Yes of the step S124), the release determining unit 506 sets the release control corresponding to the event ID in the moving image management table 504 to the pending state and makes a notification to the right holder and carries out overwriting manually or the like after a response (step S125).

Furthermore, if determining that the release check is not “desired” (No of the step S124) or after the overwriting based on the release check, the release determining unit 506 determines what the release control corresponding to the event ID in the moving image management table 504 is (step S126). If the release control is the “release,” the release determining unit 506 releases the posted moving image by the release unit 508 (step S127). For example, information to set whether or not a release is permitted regarding each moving image is made valid to make the state in which the moving image may be retrieved and viewed from the external.

Moreover, if the release control is the “release with advertisement,” the release determining unit 506 gives a given advertisement to the moving image by the advertisement giving unit 507 and releases the moving image by the release unit 508 (step S128). For example, the release determining unit 506 carries out setting of displaying in a mode such as superimposing the advertisement information on the posted moving image, displaying the advertisement information like a preview before the start of the moving image, or simultaneously displaying the advertisement information around the moving image.

If the release control is the “non-release,” the release determining unit 506 makes the moving image unreleased (step S129). For example, processing is not particularly executed if the information to set whether or not a release is permitted regarding each moving image is invalid by default. Furthermore, depending on the operator, the moving image is deleted after a given time limit is passed because of the unreleased moving image.

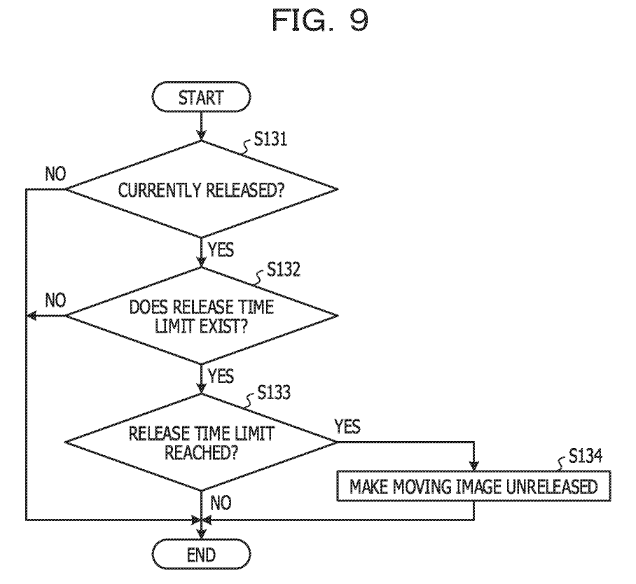

FIG. 9 illustrates a processing example by a release determining unit when a release time limit is given to a released moving image. The release determining unit may be the release determining unit 506 illustrated in FIG. 1. In FIG. 9, with reference to the moving image management table 504, regarding a moving image that is currently released (Yes of a step S131) and has a release time limit (Yes of a step S132), the release determining unit 506 determines whether or not the release time limit has been reached (step S133). The determination of whether the release time limit has been reached is carried out by comparing the present date and time and the release time limit. Then, if determining that the release time limit has been reached (Yes of the step S133), the release determining unit 506 makes the moving image unreleased (step S134). For example, the information to set whether or not a release is permitted regarding each moving image is made invalid to make the state in which the moving image is kept from being retrieved and viewed from the external.

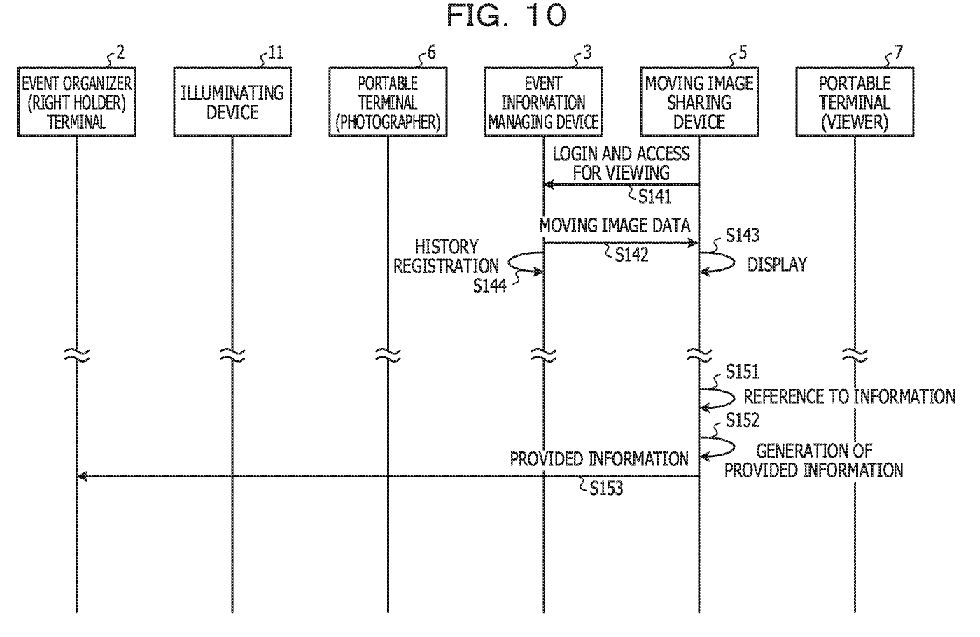

Next, processing at the time of viewing of a moving image and at the time of information provision will be described along FIG. 10. In FIG. 10, an average user who attempts to view a released moving image carries out login and access for viewing from the portable terminal 7 to the moving image sharing device 5 (step S141). Thereby, the portable terminal 7 acquires moving image data (step S142) and the moving image is displayed (step S143).

Meanwhile, the access managing unit 509 of the moving image sharing device 5 registers the history of the access in the access history table 510 (step S144). The information recorded in the access history table 510 includes the access date and time, the access user ID, and the moving image ID, as described with FIG. 5.

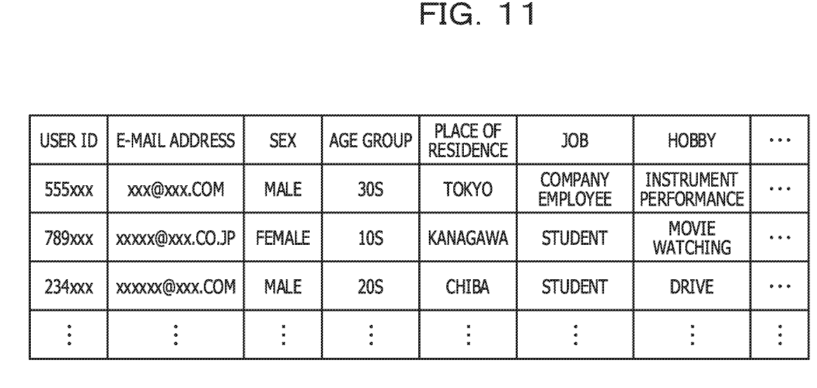

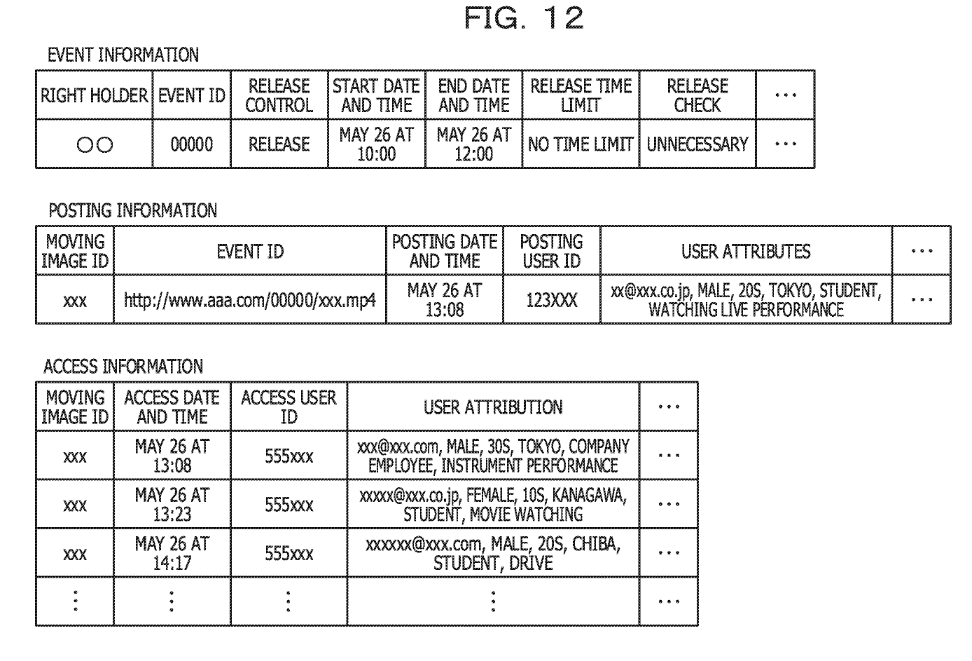

Referring back to FIG. 10, at a subsequent given timing, the information providing unit 511 of the moving image sharing device 5 refers to information in the moving image management table 504 and the access history table 510 (step S151) and generates provided information for the right holder (step S152). As the provided information, for example, for each right holder, the moving image IDs and the posting user IDs may be included in the provided information regarding the event associated with the right holder. Furthermore, for each right holder, the moving image IDs and the access user IDs may be included in the provided information regarding the event associated with the right holder. Furthermore, it is also possible to add attribute information (e-mail address, sex, age group, place of residence, job, hobby, and so forth) of a posting user or an access user by referring to user information like information illustrated in FIG. 11. FIG. 12 illustrates an example of provided information to a right holder. Besides posting information and access information, event information registered by the organizer for confirmation is also included.

For example, if the event is a concert, the right holder that has acquired the provided information puts a link to the posted moving image on a homepage of a singer or a musician and the related pages and thereby is enabled to utilize the moving image for promotion of the singer or the like. On a homepage or the like of a singer or the like, moving images merely prepared on the right holder side tend to be stereotypical. However, because it becomes possible to easily view moving images photographed by an average audience from various positions, how the concert or the like is performed may be conveyed in a real manner and it is expected to obtain a high promotion effect.

Furthermore, based on information on users who have posted moving images and users who have viewed the moving images, sending of information relating to the event and promotion such as distribution of coupons may be carried out for these users, for example. In addition, it is also possible to analyze viewing users based on the attribute information of users who have posted or viewed moving images.

Moreover, by utilizing the moving image ID of a posted or viewed moving image, the right holder may also carry out more special promotion after grasping the contents of the moving image. For example, in the case of an event of an automobile show, it is possible to determine what users take an interest in based on whether the photographed target is a cockpit of a car or the whole of the car and so forth, and switching to promotion with proper contents is enabled. If a moving image is long and includes various contents, it becomes easy to identify contents in which users take an interest by acquiring the viewed part (time zone from the start of the moving image) as part of the access history.

### MODIFICATION EXAMPLES

In the above-described embodiment, the case is described in which the event ID is issued in a centralized manner and event information is registered in advance and the event ID is included in the illumination watermark. However, various modifications may be made. For example, regarding the event ID, by combining pieces of information on the place where the event is held and the date and time when the event is held as described above, event IDs that do not overlap may be generated on the event organizer side without managing the event ID in a centralized manner. Furthermore, the advance registration of the event information may be omitted by making all or part of the event information (FIG. 3) be included in the illumination watermark within a range of the amount of information that may be embedded in the illumination watermark.

<Overview>

As described above, according to the present embodiment, pieces of content of posted moving images may be controlled for each event. Due to this, copyright control may be carried out as intended by the organizer side of the event.

Furthermore, it becomes possible for the organizer side to make secondary use of posted moving images for promotion and so forth.

The disclosed techniques are described above based on the preferred embodiment. Although the description is made by representing certain concrete examples, it is obvious that various alterations and changes may be added to these concrete examples without departing from extensive gist and range defined in the scope of claims. For example, the disclosed techniques shall not be interpreted as being limited by details of the concrete examples and the accompanying drawings.

All examples and conditional language recited herein are intended for pedagogical purposes to aid the reader in understanding the invention and the concepts contributed by the inventor to furthering the art, and are to be construed as being without limitation to such, for example, recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system comprising:
a light irradiating device configured to irradiate an object with light to illuminate a mark on the object; and
an information processing device including:
a first memory configured to store relation information and control information associated with the object, the relation information indicating a relation between the mark and the object, and the control information indicating a policy whether to distribute an image of the object to at least one device through a network; and
a first processor coupled to the first memory and configured to:
acquire the image obtained by a photograph of the object irradiated with the light to illuminate the mark on the object,
extract, from the image, the mark illuminated by the light on the object,
identify, from the image, the object associated with the extracted mark based on the relation information, and
execute a process to control distribution of the image to the at least one device through the network, according to the policy for the image of the object in the control information.

2. The system according to claim 1, wherein
the relation information further includes information corresponding to a location of the object and date and time of irradiation of the object with the light.

3. The system according to claim 1, wherein the first processor is configured to
transmit a notification indicating information relating to at least one of a posting of the image, a viewing of the image, and a combination thereof, to the at least one device through the network, to a terminal device.

4. The system according to claim 3 further comprising:
a management device including:
a second memory; and
a second processor coupled to the second memory and configured to:
receive, from the terminal device, a request to generate the control information and the relation information,
generate the control information and the relation information in response to the request, and
transmit the control information and the relation information to the information processing device.

5. The system according to claim 4, wherein the first processor is configured to:
receive, from the second processor, the control information and the relation information, and
store, in the first memory, the control information and the relation information.

6. An information processing device configured to receive an image of an object irradiated by light to illuminate a mark on the object, the information processing device comprising:
a memory configured to store relation information and control information associated with the object, the relation information indicating a relation between the mark and the object, and the control information indicating a policy whether to distribute an image of the object to at least one device through a network; and
a processor coupled to the memory and configured to:
acquire the image obtained by a photograph of the object irradiated with the light to illuminate the mark on the object,
extract, from the image, the mark illuminated by the light on the object,
identify, from the image, the object associated with the extracted mark based on the relation information, and
execute a process to control distribution of the image to the at least one device through the network, according to the policy for the image of the object in the stored control information.

7. The information processing device according to claim 6, wherein
the relation information further includes information corresponding to a location of the object and date and time of irradiation of the object with the light.

8. The information processing device according to claim 6, wherein the processor is configured to
transmit a notification indicating information relating to at least one of a posting of the image, a viewing of the image, and a combination thereof, to the at least one device through the network, to a terminal device.

9. A non-transitory computer-readable storage medium storing a program that causes an information processing apparatus to execute a process, the information processing apparatus being configured to receive an image of an object irradiated by light to illuminate a mark on the object, the process comprising:
storing, in a memory, relation information and control information associated with the object, the relation information indicating a relation between the mark and the object, and the control information indicating a policy whether to distribute an image of the object to at least one device through a network;
acquiring the image obtained by a photograph of the object irradiated with the light to illuminate the mark on the object;
extracting, from the acquired image, the mark illuminated by the light on the object;
identifying, from the acquired image, the object associated with the extracted mark based on the relation information; and
executing a process to control distribution of the acquired image to the at least one device through the network, according to the policy for the image of the object in the stored control information.

10. The non-transitory computer-readable storage medium according to claim 9, wherein
the relation information further includes information corresponding to a location of the object and date and time of irradiation of the object with the light.

11. The non-transitory computer-readable storage medium according to claim 9, wherein the process further comprises:
transmitting a notification indicating information relating to at least one of a posting of the image, a viewing of the image, and a combination thereof, to the at least one device through the network, to a terminal device.
